(19) United States
(12) Patent Application Publication
(10) Pub. No.: US 2013/0185253 A1
(43) Pub. Date: Jul. 18, 2013

(54) WEB SERVICE FOR USER AND SUBSCRIPTION DATA STORAGE

(71) Applicant: MICROSOFT CORPORATION, Redmond, WA (US)

(72) Inventors: Yunus Mohammed, Bellevue, WA (US); Christopher J. Gariepy, Bothell, WA (US); Suresh Sunku, Bellevue, WA (US); Apurva F. Dalia, Sammamish, WA (US); Sandeep Karanth, Bangalore (IN)

(73) Assignee: MICROSOFT CORPORATION, Redmond, WA (US)

(21) Appl. No.: 13/772,275

(22) Filed: Feb. 20, 2013

Related U.S. Application Data
(63) Continuation of application No. 11/726,862, filed on Mar. 21, 2007, now abandoned.

(51) Int. Cl. G06F 17/30

(52) U.S. Cl. CPC G06F 17/30283
USPC 707/609

(57) ABSTRACT

A data service that manages user and subscription data for multiple services. The data service maintains a database of the user and subscription data and provides an interface that allows the other services, that act as clients to the data service, to access that data. The data service avoids the need for the client services to implement a framework to manage the storage of user and subscription data. The data service also allows user profile data to be updated by one client service and used by all others. Further, data, such as usage history or information on policy violations, may be shared by multiple services.

### CROSS-REFERENCE TO RELATED APPLICATIONS

This patent application is a continuation of U.S. patent application Ser. No. 11/726,862 titled “WEB SERVICE FOR USER AND SUBSCRIPTION DATA STORAGE” which was filed on Mar. 21, 2007 and which is expressly incorporated herein by reference.

### BACKGROUND

Computer-based services are frequently provided over networks, such as the Internet. Such services may provide downloads of data or software or may perform functions in response to a user request. For example, a company providing application programs may maintain such a service and may periodically provide updates to that application that may be downloaded by users who have a license to use the application. As another example, a service may include a server executing multiple collaboration tools, such as a calendar, task manager or “white board.” Each tool, when accessed, may allow multiple users to interactively perform a function.

Frequently, such services are made available on a subscription basis. Before a service provides a download, it may verify that a user requesting the download is covered by a subscription agreement under which that user is entitled to receive the requested information. Likewise, before a service performs a function at the request of a user, the service may verify that a subscription agreement is in place that entitles that user to have such a function performed. In the example of a service that provides multiple collaboration tools, verifying entitlement may entail verifying that the user requesting a function is entitled to access a specific tool that will perform a requested function.

Subscription agreements establishing user entitlement may be between the entity providing the service and an individual user. Alternatively, agreements may be entered into between the entity providing the service and an organization with multiple individual users. Regardless, when a service receives a request, whether for a download or for a function to be performed by the service, the service checks the subscription state of the user to verify that the user is entitled to receive the service.

Implementing agreements entitling a user to access a service may be simplified through the use of a “passport service” that reduces the burden on the user of providing user information to multiple services. The passport service stores information about users. When a user needs to provide user information to a service, rather than providing the information directly to the service, the user may have the passport service provide the information from its store. To maintain security, the passport service may first authenticate the user, such as by receiving a password, before providing user information to the service.

The actions that cause the passport service to provide user information may be partially automated. For example, a web browser for a user that subscribes to a passport service may be configured to alert services that can accept user information from a passport service that the user subscribes to the passport service. When the service requires user information, the user may be connected to the passport service to provide authentication information. Upon authentication, the passport service may provide a certificate to the user that the user can then provide to the service that requires user information. The passport service may provide this certificate as a “cookie” that can be automatically passed from the user's web browser to the service. The service can then contact the passport service using the certificate in the cookie to obtain user information, without further user involvement.

### SUMMARY OF INVENTION

Applicants have appreciated that the storage of user and subscription data by services can be simplified by providing one or more data services that maintain user and subscription data for multiple services. Though different services maintain different types of user and subscription information, in instances where there is overlap in the types of data stored by different services, the total burden on both users and services is reduced by having user and subscription data for multiple services maintained by a data service. Information updated through one service may be automatically updated in other services. Moreover, certain types of subscription data are applicable across multiple services and providing a data service to maintain subscription data from multiple services provides a simple mechanism to make this information available to all of the services or to aggregate information from multiple services to provide different or better functionality relating to subscription management. Further, even when different user and subscription data is used by different services, there may be significant commonality in the framework needed to maintain this data. A data service may provide this framework for multiple services, thereby reducing the need for individual services to implement user and subscription data management functions and simplifying implementation of those services.

A data service to maintain user and subscription data may be implemented as one or more web services that are accessible by other services through a defined interface. In some embodiments, the data service is implemented as a web service accessible through an API. The API may provide a framework for the service to store, retrieve and modify user and subscription data. Further, the API may provide a framework through which a service may define the format for storing user and subscription data.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a computer system incorporating a web service for user and subscription data storage according to an embodiment of the invention;

FIG. 2A is a sketch of a data structure maintained by the web service of FIG. 1;

FIG. 2B is a sketch showing a first portion of the data structure of FIG. 2A in greater detail;

FIG. 2C is a sketch showing a second portion of the data structure of FIG. 2A in greater detail;

FIG. 3 is a flow chart of a method of operating a web service for user and subscription data storage according to an embodiment of the invention; and

FIG. 4 is a functional block diagram of an apparatus for providing a web service for user and subscription data storage according to an embodiment of the invention.

### DETAILED DESCRIPTION

Implementation and/or operation of subscription-based services may be improved by a data service that stores user and subscription data. The data service may provide an interface through which multiple services, acting as clients to the data service, may access user and subscription data. The interface may allow the client services to read or write data in predefined formats and/or in formats defined by the client services. As a result, the data service may provide a framework for storing user and subscription data that avoids the need for individual client services to provide such a framework.

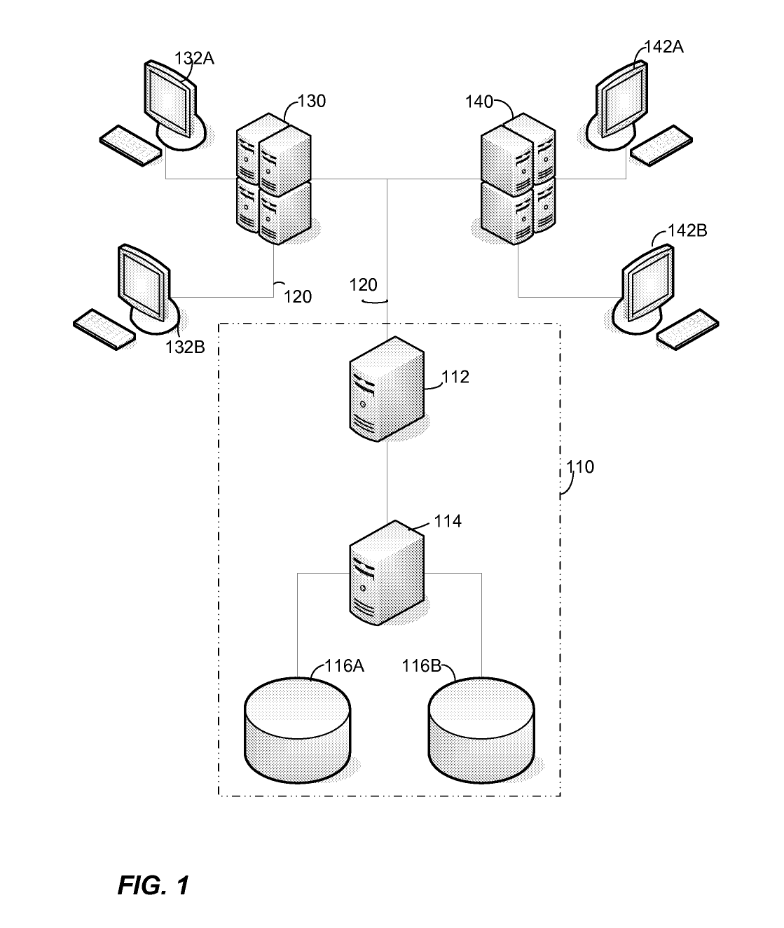

A data service for user and subscription data may be implemented as one or more web services accessible over the internet or other suitable network. FIG. 1 illustrates a computer system incorporating such a web service according to an embodiment of the invention.

Data service 110 may be implemented using known hardware and software components or any other suitable components. In the embodiment illustrated, data service 110 is implemented as a web service with web server 112 providing an interface to the service over a network 120. In the embodiment illustrated, network 120 may be the Internet or any other suitable network. Accordingly, webserver 112 may be implemented using known webserver technology. However, as described in greater detail below, webserver 112 may be programmed to implement an Application Programming Interface (API) that allows one or more client services to access user and subscription data maintained by data service 110.

To maintain stored data, web server 112 interacts with database server 114. Database server 114 interacts with one or more databases, here illustrated as databases 116A and 116B. The databases 116A and 116B may store user and subscription data in an organized fashion that allows information about individual users and/or organizations to be associated with information about subscriptions those users or organizations may have to one or more other services accessible over network 120. The specific format in which user and subscription data is stored in databases 116A and 116B is not critical to the invention. Further, though two databases 116A and 116B are illustrated, all user and subscription data alternatively may be stored in a single database or three or more databases. Accordingly, the number and type of databases in data service 110 is not a limitation on the invention.

Likewise, database server 114 is shown separate from web server 112, but the invention is not limited to implementation in this fashion. Though the servers may be implemented as physically separate devices, both web server 112 and database server 114 may be performed within the same physical device. Accordingly, the specific hardware and software components used to implement data service 110 is not a limitation on the invention.

In operation, data service 110 may interact with one or more other services over network 120 that act as client services to data service 110. Those services may provide information or functionality to users on a subscription basis. Those client services may use data service 110 to store user and subscription data.

In the embodiment illustrated in FIG. 1, client services 130 and 140 are shown. Though two services are shown, data service 110 may interact with any number of client services. Each of the client services 130 and 140 may be implemented using conventional hardware and software components or any other suitable components. In the embodiment illustrated, client services 130 and 140 are each implemented with a cluster of server devices, allowing them to provide services for multiple users. However, any suitable hardware or software components may be used to implement client services 130 and 140.

In the embodiment illustrated in FIG. 1, each of the client services 130 and 140 provides services according to subscription agreements that entitle individual users to services. The specific type of services provided by client service 130 and client service 140 are not a limitation on the invention. For example, client service 130 may provide users with software downloads or downloads of other information.

In the embodiment illustrated, users (not shown) may access client service 130 through user devices, of which user devices 132A and 132B are illustrated. Access to the client services may be initiated manually or automatically or initiated in any other suitable way. For example, a client service may be accessed in response to user input entered through a web browser or similar interface. Alternatively, a client service may be accessed in response to execution of a wizard, background task or other automated or partially automated process.

User devices 132A and 132B are here shown as desktop computers connected through network 120 to service 130. These computers may be configured to access one or more client services with software as is conventionally used for accessing a service over a network or any other suitable software. However, the specific mode of user access to the client services is not a limitation of the invention.

The specific functions provided by client service 130 are not critical to the invention. Service 130 may, for example, provide downloads of software or other information. Alternatively, service 130 may perform functions in response to requests entered by users through user devices such as 132A and 132B. Examples of functions that may be executed by service 130 include online collaboration functions and email related functions.

Client service 140 may similarly provide downloads of software or other information or may perform functions in response to user requests. In the embodiment illustrated, users access client service 140 through user devices 142A and 142B. In this example, user devices 142A and 142B are within organization 150. Organization 150 may represent a company or other enterprise that may subscribe to the services provided by client service 140. Accordingly, users accessing client service 140 may be entitled to services indirectly as a result of a subscription agreement between the organization and client service 140.

Both client services 130 and 140, prior to providing a service in response to a user request, may verify that the user is entitled to receive the requested service. In the scenario in which organization 150 has subscribed to service 140, service 140 may verify that a user is entitled to services by determining that the user requesting the services is within organization 150. Known mechanisms for determining that a user is within an organization may be used. Though, such a determination may be made in any suitable fashion. In contrast, service 130 has subscription agreements with individual users. Accordingly, when service 130 receives a request for a service, it determines whether the user requesting the service is entitled to receive that service by verifying that the service is covered under a subscription agreement with the user.

Though FIG. 1 shows service 130 providing services based on agreements with individual users and service 140 providing services based on agreements with an organization 150, each service may provide services based on agreements with any one or more type of entity. For example, though not pictured, service 130 may provide services to some users based on individual agreements with those users and services to other users based on agreements with organization with which individual users may be associated.

Regardless of the number and types of agreements that each of the services 130 and 140 may provide, each of the client services 130 and 140 may use data service 110 to store information about users, organization or other entities that are entitled to services. The client services may use data service 110 to store information about agreements through which each such entity may be entitled to services.

To access user or subscription data, each client service 130 or 140 may interact with data service 110 over network 120. Webserver 112 may provide an interface to client services 130 and 140 so that the client services may store or retrieve information relating to a user or a subscription. The interface provided by web server 112 may also allow specify services 130 and 140 to specify parameters controlling the storage or retrieval of information relating to a service or to access the information in any other suitable way.

As web server 112 receives requests to access information relating to a user or a service, web server 112 may interact with database server 114 to form records in databases 116A and 116B that store the user and subscription data with desired associations that allow information about subscriptions associated with services and services associated with users to be accessed.

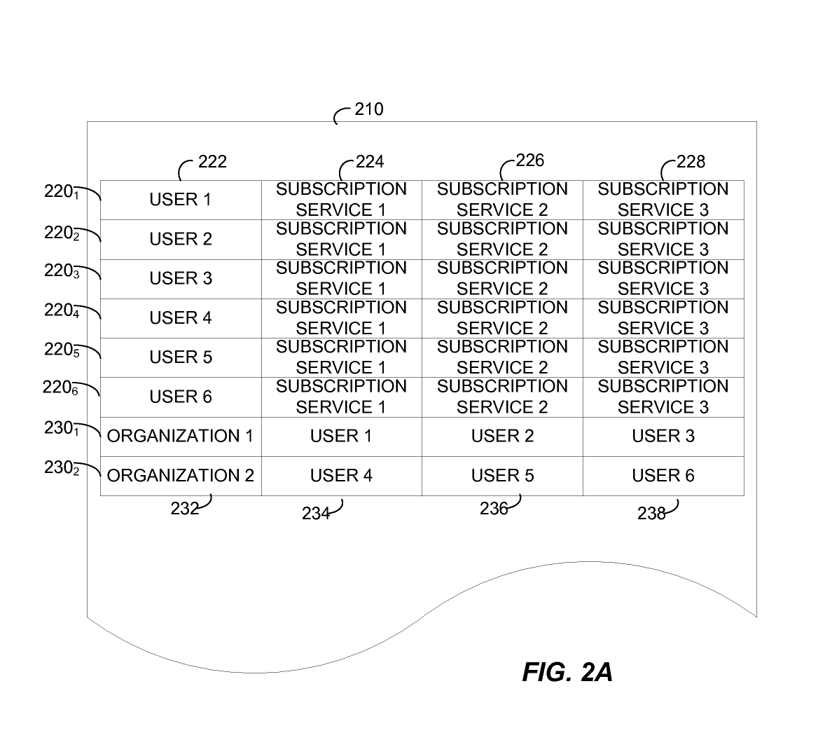

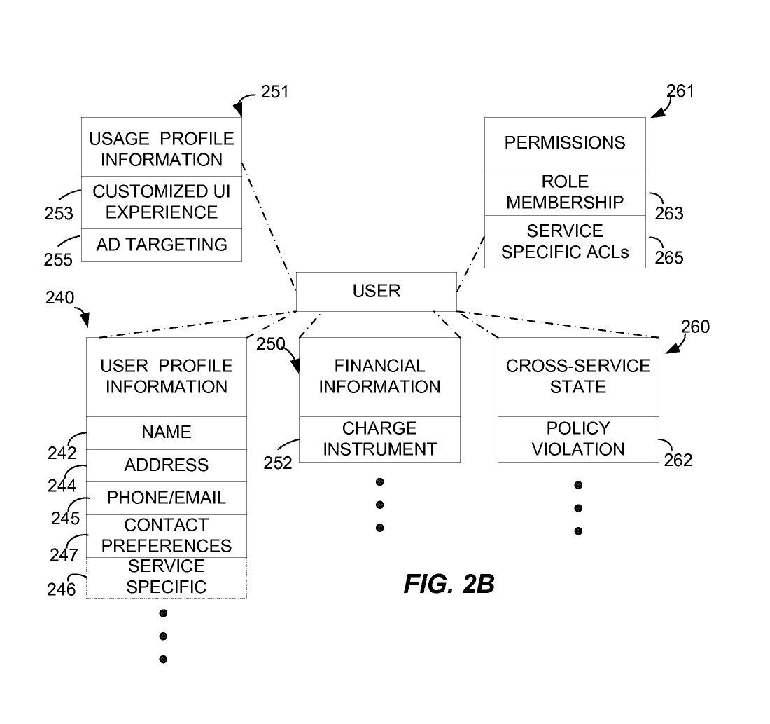

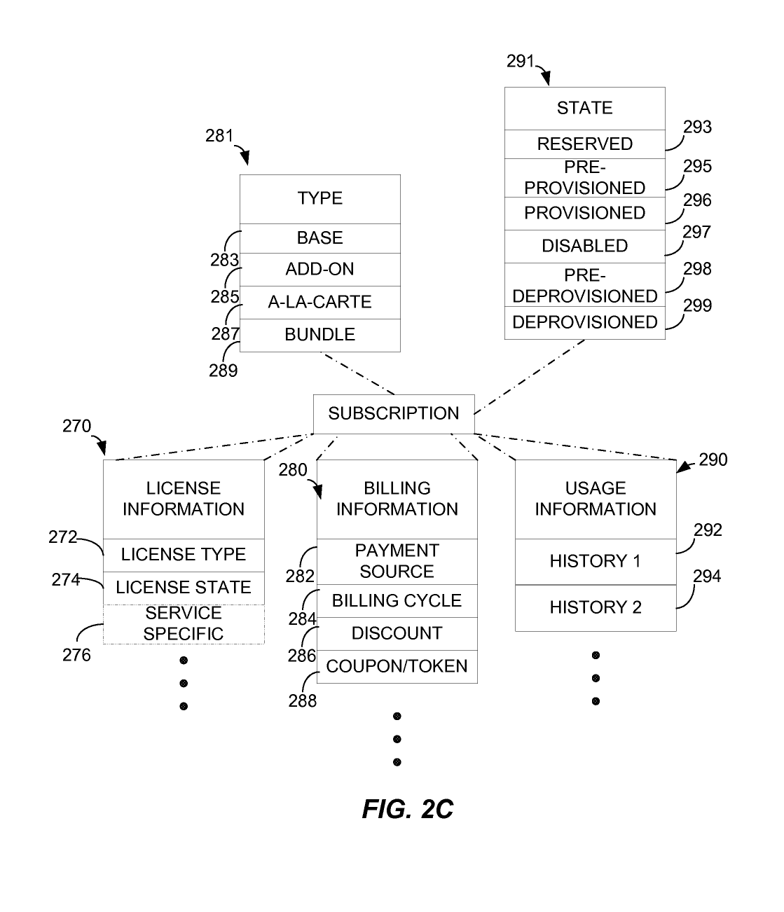

FIG. 2A illustrates schematically a data structure that may be formed in response to interactions between services, such as services 130 and 140, and data service 110. The data structure illustrated in FIG. 2A may be formed by data service 110 in a computer readable medium 210, which may be a portion of either database 116A or 116B. Though, computer readable medium 210 may be nonvolatile computer memory coupled to database server 114 or may be any other suitable computer readable medium.

In the embodiment illustrated in FIG. 2A, the data structure maintained by data service 110 contains multiple records 220₁ . . . 220₆ and 230₁ . . . 230₂. In this example, six records 220₁ . . . 220₆ are shown containing data associated with users as individuals. Three records 230₁ . . . 230₂ are shown storing information associated with organizations. This number and type of records is shown for simplicity. A data structure according to embodiments of the invention may contain information about any number of users, organization or other entities and may be organized in any suitable way.

Record 220₁ is illustrative of a record that may be used to organize user and subscription data for an individual user. Record 220₁ includes fields 222, 224, 226 and 228, each storing user and/or subscription information. In the embodiment illustrated, field 222 stores information about a user that is not specifically tied to a subscription. Field 224 stores information related to a subscription to a client service. In the example of FIG. 2A, that service is identified as “SERVICE 1.” As illustrated, field 224 and field 222 are both contained within record 220₁, indicating that field 224 stores information about a subscription USER 1 has to SERVICE 1. Other fields may be included in record 220₁ to store information about subscriptions USER 1 has to other services. In the example illustrated, fields 226 and 228 are shown, storing information about a subscription to SERVICE 2 and SERVICE 3, respectively.

In the example of FIG. 2A, records are used to indicate that information is stored in a way that information about a user may be associated with information about one or more services. Such an association may be captured by the physical locations within computer-readable medium 210 at which information is stored. However, use of the term “record” need not imply that there is any physical organization to the data. Tags or other metadata may be used to create associations implied by the records pictured in FIG. 2A and the invention is not limited by the manner in which data is organized or stored.

The data structure of FIG. 2A may contain other records associating information about other users with subscription information for one or more services. As shown in FIG. 2A, records 220₂ . . . 220₆ associate information about USER 2 . . . USER 6 with subscriptions to one or more services. Though FIG. 2A shows all of the records 220₁ . . . 220₆ containing fields storing information about three services, it is not necessary that each record store information about the same services or about the same number of services.

The data structure in FIG. 2A also stores information about organizations and users who are a part of those organizations. Records 230₁ and 230₂ each stores information about an organization and users within that organization. Record 230₂ provides an example of data that may be stored in connection with an organization, here identified as ORGANIZATION2.

As shown, record 230₂ includes a field 232 storing information about the organization. The information stored in field 232 may parallel the information stored in field 222 concerning a user. However, rather than pertaining to a single user, the information in field 232 may identify an entire organization, such as a company or an enterprise. In this way, field 232 indirectly provides user information by providing information relevant to users that are part of the organization.

Other fields in record 230₂ provide information about users that belong to ORGANIZATION 2. In the example illustrated, fields 234, 236 and 238 each identify a user that is a member of the organization described by record 230₂. Each other organization about which data is maintained may have similar records similarly defining users of that organization.

The type of information stored in each field may depend on the services to which a user or organization has subscribed or the specific terms of those subscriptions. Accordingly, it is not necessary that each record store the same type of information. For example, some services may store user identification information not used by other services, such as a client code or demographic information. Similarly, different services may store different subscription information. For example, a service that provides access to one or more tools may store information defining the specific tools to which a user has subscribed. In contrast, no comparable information may be stored for a service that provides a single class of service rather than providing different subscriptions that allow access to different tools. Accordingly, data service 110 (FIG. 1) may provide mechanisms for each client service to specify the type or format of information stored for use by that client service.

Turning to FIG. 2B, further detail of user information that may be stored in the data structure of FIG. 2A is shown. Each field, such as field 222, storing user information may contain multiple subfields, each storing a different type of information. Any number of subfields may be used, storing any desired type of data. In the pictured embodiment, data service 110 is configured to provide a set of subfields storing certain types of user information.

As one example, FIG. 2B shows that user information, such as may be stored in field 222, may be stored in multiple types of subfields. For example, subfields may be provide to store user profile information 240. In this simple example, user profile information is stored in subfield 242, which stores a user name. Subfield 244 is provided to store a user address. Subfield 245 may store a phone number and/or an email address for the user. Subfield 247 may store one or more contact preferences, indicating a preferred method for contacting the user.

If a client service requires user profile information in addition to a name and address, data service 110 may allow that client service to define a subfield, such as service specific subfield 246. Any suitable mechanism may be used to define a subfield. For example, a client service may cause data service 110 to perform a function that creates a new subfield in a record to hold a defined type of information. As an alternative, the client service may cause data service 110 to use a previously created subfield for information of a type specific to that service. Regardless of the mechanism used to create a service specific subfield, the client service defining service specific subfield 246 may specify characteristics of that subfield, allowing it to store any desired type of information.

Other subfields may store financial information 250 related to a user. For example, FIG. 2B shows a subfield 252 storing information about a charge instrument that may be used to pay periodic subscription fees. Subfield 252 may store a credit card number, an account number for a prepaid account or other information identifying a charge instrument. However, it is not necessary that a subscription agreement entail payment of a subscription fee. Accordingly, in some cases client services may not collect information on a payment source. In such a scenario, subfield 282 may not be present or may not contain data.

User information may also include cross-service state information 260. Cross-service state information 260 may be any other information useful in implementing one or more subscriptions for a user to one or more client services. In the specific example of FIG. 2B, cross-service state information 260 contains policy violation information stored in subfield 262. The information in subfield 262, for example, may indicate that a user has violated terms of use of a client service. Such information may be useful in administering other client services. For example, subfield 262 may store an indication that a user has violated a policy against posting offensive information in a public forum. Such information may be used in managing other client services to avoid problems by restricting the same user from accessing portions of other client services that allow the user to make public postings.

Data service 110 may also maintain usage profile information 251 about each user. In the embodiment illustrated, usage profile information 251 contains subfield 253 storing information about user interfaces that are presented to the user as part of accessing client services. This information, for example, may be used to present a customized user interface experience. Subfield 255 may also contain information used for customizing a user experience. In this example, information in subfield 255 may be generated by processing data within the data service 110 to aggregate information provided by one or more client services to obtain information about the user. In this example, subfield 255 is used to store information about advertising material that may be of interest to the user.

Permissions information 261 may also be stored. This information may be used by a client service to grant or deny the user access to specific functions of the service. In this example, permissions information 261 contains a subfield 263, storing a role membership for the user. Client services that grant access to users based on their roles within an organization may use this information to grant or deny access to a specific user. Permissions information 261 also contains subfield 265. Subfield 265 may contain one or more access control lists generated by client services.

Though not expressly shown in FIG. 2B, fields, such as field 232, storing organization information may similarly contain multiple subfields. As with the user information shown in FIG. 2B, the subfields storing organization information may contain profile information identifying the organization, financial information relating to payment of services and one or more types of cross-service state information. As with the user information shown in FIG. 2, data service 110 may allow a service to define one or more additional subfields to contain service specific organization information.

FIG. 2C shows that subscription information stored in the data structure of FIG. 2A may also be stored in multiple subfields. As with the user information illustrated in FIG. 2B, data service 110 may define a predetermined number and type of subfields to store subscription information and may allow services to define additional or different subfields for service specific subscription information.

Though the types of the subscription information that may be stored by data service 110 are not limited by the example of FIG. 2C, FIG. 2C shows that subscription information may contain license information 270, billing information 280 and usage information 290. Each of these types of subscription information may be stored in one or more subfields. For example, license information 270 is shown to be stored in subfields 272 and 274. Subfield 272 may store an indicate of a license type. When a client service provides access to different collections of tools based on the type of subscription entered into by a user, such a field, for example, may be used to store information indicating specific tools to which a user is entitled.

Subfield 274 may store information about the license state. For example, subfield 274 may indicate that the license is in force or that it will expire on a certain date. If additional information is required to define a license associated with a subscription, one or more additional service specific subfields, such as subfield 276 may be defined to store service specific information.

Billing information 280 may be stored in one or more subfields, such as subfield 282, indicating the source of payment for the subscription. The source of payment may be a charge instrument identified in subfield 252 (FIG.2B) or other suitable source of payment. Subfield 284 may store information about the billing site for a subscription, indicating when users are billed for the subscription. Subfield 286 may provide information about discounts that are available for a subscription and subfield 288 may be used to store information about coupons or tokens that may be used as a mechanism to pay for the subscription.

Usage information 290 may be stored in one or more subfields, such as subfields 292 and 294. Subfields may store information defining the nature of the services accessed or the frequency of usage or any other usage information that a service may use.

Subscription-type information 281 may also be stored in one or more subfields. Type information may define subscription characteristics that are different, depending on the type of subscription. For example, subfields 283, 285, 287 and 289 may define characteristics of the subscription when provided to a user as a base subscription, an add-on subscription, an a la carte subscription or a bundle subscription, respectively.

Subscription state information 291 may also be stored in one or more subfields. In the example illustrated in FIG. 2C, subfields 293, 295, 296, 297, 298 and 299 provide information relevant to a reserved state, a pre-provisioned state, a provisioned state, a disabled state, a pre-deprovisioned state and a deprovisioned state, respectively.

FIGS. 2A, 2B and 2C provide one example of a format in which user and subscription data may be stored by a data service. However, any suitable format may be used. For example, FIG. 2A shows that records 220₁ and 230₁ store information related to USER 1 rather than storing all of the information identified in FIG. 2B for a user in both records 220₁ and 230₁. The types of information depicted in FIG. 2B as defining the user may be stored once for USER 1. Record 220₁ and 230₁ may then provide information describing user 1 by making reference to this separate store of information about USER 1. Similarly, each of the records 220₁ . . . 220₆ stores information about subscriptions. The information about each subscription may be stored once in computer readable media 210, with each of records 220₁ . . . 220₆ containing a pointer or other reference to this store as appropriate to identify specific subscriptions for the purposes of showing relationships between users and subscriptions. Regardless of the format used, multiple client services may access the data through data service 110. In this way, data service 110 may provide a framework for managing user and subscription data, avoiding the need for each client service to provide its own framework.

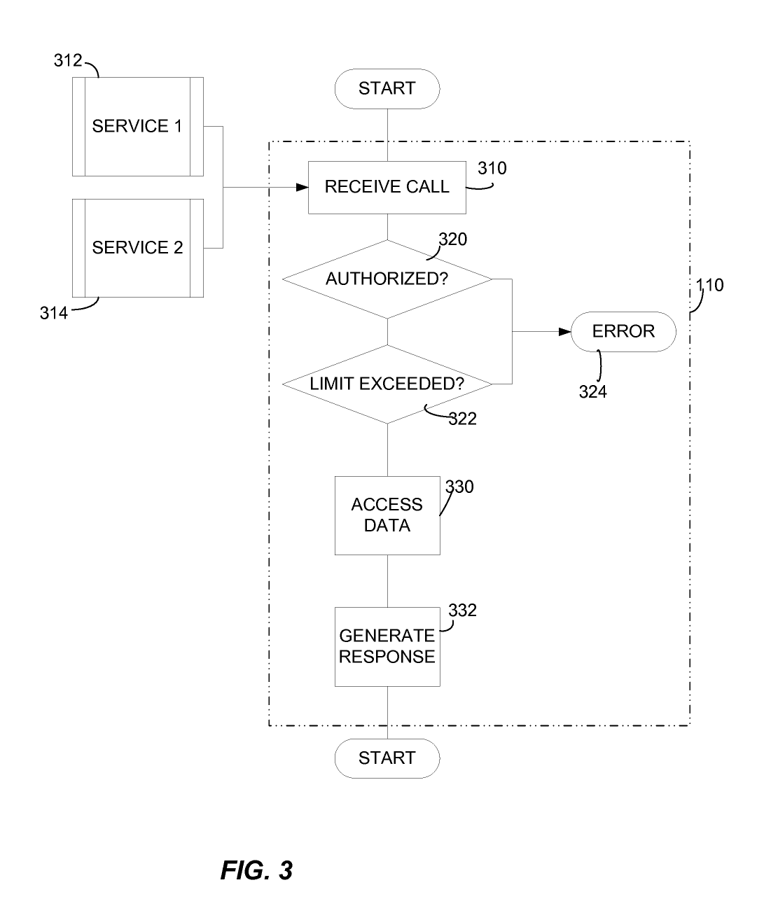

FIG. 3 is a flowchart of a process in which one or more client services accesses data maintained by data service 110. In the embodiment of FIG. 3, data service 110 maintains an interface through which client services may place calls to access data. Calls through these interfaces may cause data service 110 to store or retrieve data. Calls to the interface may alternatively or additionally define a format in which information is stored. Accordingly, the process of FIG. 3 begins at block 310 where data service 110 receives a call from a client service. In this example, client service 312 and client service 314 are illustrated, either of which may place a call to data service 110.

Data service 110 may implement an interface in any suitable format so that client services 312 and 314 may place calls on that interface. In the illustrated embodiment, data service 110 implements a SOAP interface. A SOAP interface may contain methods that, when called, perform functions. Data service 110 may implement an interface with methods that store or retrieve information. Additionally, methods of the interface may allow services to define formats for information to be maintained by data service 110 or otherwise access data stored by the service.

Regardless of the specific function to be performed in response to the call, data service 110 may, prior to performing that function, validate that execution of the function complies with operating policies of data service 110. Any number or type of policies may be defined for data service 110 to ensure data security or data integrity, to avoid overloading data service 110 or to otherwise limit use of data service 110.

In the embodiment illustrated in FIG. 3, determinations are made at decision blocks 320 and 322 to determine whether a call complies with the policies of data service 110. If the call does not comply with policies of data service 110, processing branches to error handler 324. At error handler 324, any suitable error handling processing may be performed. For example, an error message may be generated or a record of a call in violation of a policy of data service 110 may be logged.

In the embodiment illustrated, the process branches to error handler to 324 from decision block 320 if the client service placing the call is not authorized to make such a call. Any suitable policies may be used for determining whether a client service is authorized to make a call. For example, some client services may be authorized to read data from data service 110. In contrast, other client services may be authorized to both read and write data to data service 110. If a client service authorized for read-only access places a call on the interface to data service 110 for a method that would write or modify data stored by data service 110, processing made branch to error handler 324.

In the foregoing example, access to functions of data service 110 may be controlled on a method call-by-method call basis. Authorization may be provided alternatively or additionally in other ways, such as based on the specific data to be accessed. For example, a client service may be authorized to modify the format of data stored in a field or subfields of the data structure of FIG. 2A only if those fields or subfields were previously defined by that client service. Accordingly, a call by a client service requesting a modification to a field defined by another client service may result in the process branching to error handler 324.

Regardless of the specific policies used to determine whether a call is authorized, if a call is not authorized, processing branches from decision block 320 to error handler 324. Conversely, if the call is authorized, the process continues to decision block 322. At decision block 322, additional criteria may be applied to determine whether the call complies with policies of data service 110. In the example illustrated, processing at decision block 322 determines whether the call exceeds a limit imposed by a policy of data service 110. For example, data service 110 may implement the policy in which the frequency or other parameter of calls on data service 110 is limited. If the call received at block 310 exceeds the limit, processing branches to error handler 324. Conversely, if the call received at block 310 does not exceed the limit, processing may proceed to block 330.

At block 330, a database maintained by data service 110 may be accessed. Access at block 330 may involve reading, writing or modifying data stored in a database. The specific function performed as part of the access at block 330 may depend on the method called by the client service. As a specific example, if the method called at block 310 specifies information about a subscription to be stored in association with a user, access at block 330 may entail recording that subscription information in conjunction with information relating to that user.

Regardless of the specific function performed as part of data access at block 330, processing continues at block 332 where a response may be generated. For method calls that entail retrieving information from the database, generating a response at block 332 may entail formatting the retrieved information to return that information to the client service through the interface to data service 110. For method calls that entail storing information, the response generated at block 332 may include an acknowledgement that the data was stored as requested. However, in some embodiments, some method calls may not result in a response being returned to a client service. Accordingly, processing at block 332 may not be performed in response to all calls on data service 110.

Regardless of whether a response is generated, processing of a call on the interface of data service 110 may terminate, with the processing to be repeated when a subsequent call is received.

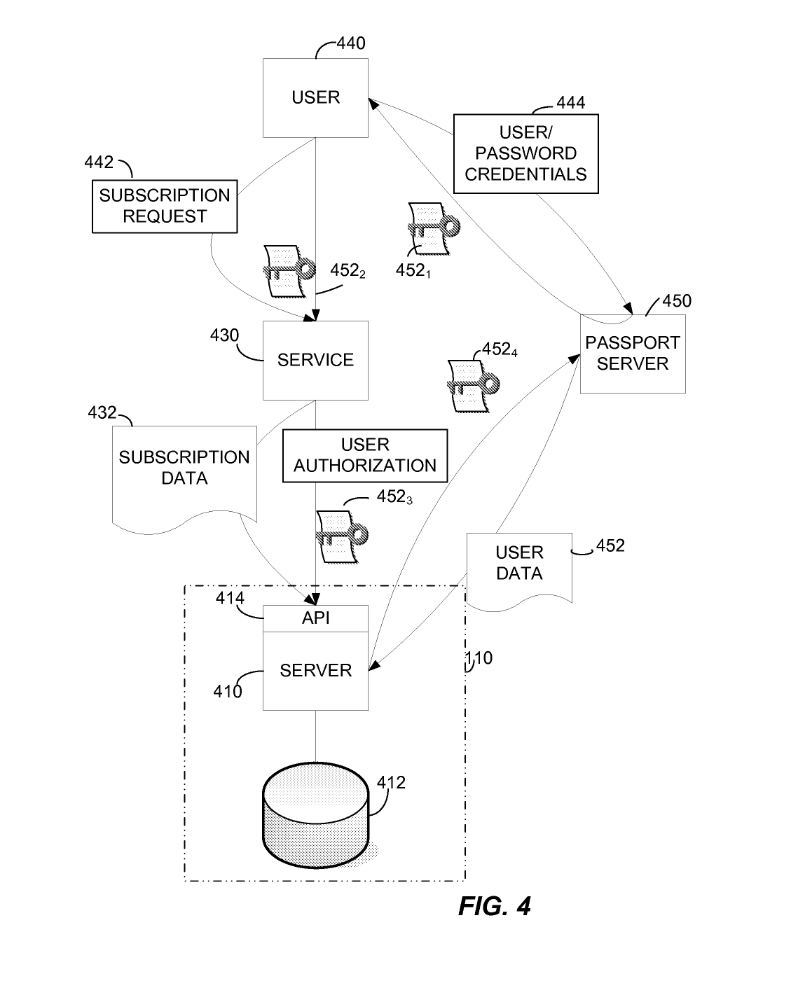

FIG. 3 illustrates that, at decision block 320, a determination is made of whether a call received at data service 110 is authorized. FIG. 4 illustrates an embodiment of a system in which a certificate generated by a passport server is used as part of the process of determining whether a method call is authorized. Such a process may be used when access to user and subscription information is controlled on a user-by-user basis so that client services may only access information about users that are actively accessing those client services.

FIG. 4 shows a data service implemented on a server 410 providing an application programming interface (API) 414 through which one or more client services may place calls to access user and subscription data stored in database 412. In the example of FIG. 4, a single client service 430 is illustrated. However, a single client service is shown for simplicity of illustration and any number of client services may place calls through API 414 to access data in database 412.

A user 440 may interact with service 430 to establish a subscription as in a conventional service, though information about user 440 may be provided by passport server 450 rather than directed from user 440. In this example, user 440 maintains an account with a passport server 450 that stores user information. Client service 430 is configured to operate in conjunction with passport server 450 to obtain user information when user 440 requests client service 430 to perform a function requiring user information.

For example, to establish a subscription with client service 430, user 440 may send a subscription request 442 to client service 430. Such a subscription request may be in any suitable format. For example, client service 430 may be an update service associated with an application program. User 440 may send subscription request 442 as part of registering the application program. Though, subscription request 442 may be generated in any suitable way. For example, user 440, through interaction with a web browser, may control the web browser to generate subscription request 442 that is transmitted over a network to service 430. Alternatively, subscription request 442 may be generated by a registration wizard executed by user 440 as part of registering an application program.

Regardless of why and how subscription request 442 is generated, in addition to the subscription request 442, a user may transmit information identifying the user to client service 430. In this example, user identification information is transmitted in the form of an authenticated ticket generated by passport server 450.

In the embodiment illustrated, user 440 sends user/password credentials 444 to passport server 450. User/Password credentials 444 may be generated in any suitable way. In response to user/password credentials 444, passport server 450 generates an authenticated ticket 452₁. Authenticated ticket 452₁ may be returned to user 440 such that authenticated ticket 452₂ may be provided to client service 430.

Service 430, in response to receiving subscription request 442 and authenticated ticket 452₂, may authorize the user and establish a subscription for user 440. To track this subscription, client service 430 may cause data service 110 to store information concerning user 440 and the subscription in database 412. Service 430 may cause data service 110 to store this information in database 412 by placing a call through programming interface 414.

Calls through API 414 may include subscription data 432 and a client certificate and, optionally, authenticated ticket 452₃ generated by passport server 450. The subscription data 432, client certificate and authenticated ticket 452₃ may be provided in any suitable way, such as as parameters to a method call requesting server 410 to store information indicating that user 440 has a subscription to client service 430.

Server 410 may use authenticated ticket 452₃ to obtain information from passport server 450 on user 440. In this example, server 410 provides authenticated ticket 452₄, prompting passport server 450 to respond with user data 452. This exchange of data between server 410 and passport server 450 provides user data 452 to server 410.

Server 410 may use user data 452 to store subscription data 432 with a format that associates the subscription with user 440. For example, server 410 may use user data 452 to determine whether a record exists in database 412 for user 440. If a record already exists, server 410 may cause subscription data 432 to be added to that record such that subscription data 432 becomes associated with that user and other subscription data already stored for that user. If no record exists for user 440, server 410 may use user data 452 to create a new record and store subscription data 432 in that record.

In addition, server 410 receives an identification of user 440 in the format of a copy 452₃ of a certificate issued by passport server 450 in response to action by user 440 while user 440 is in communication with client service 430. As a result, server 410 can determine that client service 430 is actively communicating with user 440. In the embodiment illustrated in FIG. 4, server 410 implements a policy that allows a client service to only access data associated with users actively communicating with that service. As a result, copy 452₃ of the certificate from passport server 450 is used to validate that client service 430 is authorized to access information relating to user 440.

Data service 110 may store user and subscription data in a format that multiple client services may access the data through API 414. API 414 may have any suitable format. In some embodiments, the interface is a SOAP interface, which may have a format as described in greater detail below.

### Classes

The interface may include classes, each of which defines the properties of an object in which data may be stored. Specific objects may be formed by creating instances of objects of these classes and assigning values corresponding to the properties.

Examples of classes that may be used to implement an interface are provided below.

Certain properties may have defined ranges of allowed values. Data server 110 (FIG. 1), upon receiving an object, may validate that the specific values provided for properties of that object fall within the defined ranges. Error processing may be performed if a property of an object has a value outside of the defined range. Examples of ranges of allowed values, and possible actions that may occur when objects have values outside these ranges are provided under the “Notes” headings below.

Each class that can be used to add or update data in a database maintained by a data service may have a “Changes” property. A changes property may be implemented as a bit field of enumerated type, with a type unique to each object. To indicate which properties have been set and should be written to the database when an object is passed through the interface, this field may be set by a service accessing the data service. Properties for which the matching flag has not been set to true will not be added and/or updated.

In addition to the specific properties identified below, each class may have properties as indicated below.

Class: all (selected)

| Property | | |
|---|---|---|
| Name | Type | Notes |
| Modified | DateTime | The modified property will be ignored if supplied |
| | | by callers during an Add or Update call. On data |
| | | retrieval calls it is populated from the |
| | | ModifiedDate field in the db. It exists for the |
| | | following classes: |
| | | User |
| | | Address |
| | | Email |
| | | Phone |
| | | Agreement |
| | | CustomProperty |
| | | QuestionAnswer |
| | | Subscription |
| | | Product |
| | | ProductRegistration |

### User Class

A user class, used to create objects represent users may be defined to have the following properties:

Class: User

Notes:

| Property Name | Type | Notes |
|---|---|---|
| Id | UserId | |
| AltId | AltUserId | |
| State | Int | |
| IsBusiness | Bool | |
| CompanyName | String | |
| Name | UserName | |
| Addresses | Address[ ] | |
| Phones | Phone[ ] | |
| Emails | Email[ ] | |
| Locale | String | |
| TimeZone | Enum: | |
| | TimeZoneRange | |
| Agreements | Agreement[ ] | |
| QuestionAnswers | QuestionAnswer[ ] | |
| CustomProperties | CustomProperty[ ] | |
| Subscriptions | Subscription[ ] | |
| Products | Product | |
| ProductRegistrations | ProductRegistration | |
| Privacy | UserMasterPrivacy | |
| Created | DateTime | In addition to standard |
| | | Modified property also |
| | | includes Created time. |
| Changes | Enum: | |
| | UserProperties | |

Class: UserName

| | | |
|---|---|---|
| Property Name | Type | Notes |

| | |
|---|---|
| First | String |
| Middle | String |
| Last | String |
| Full | String |
| Friendly | String |
| Prefix | String |
| Suffix | String |
| Changes | Enum: UserNameProperties |

UserId Class

In some embodiments, UserId is the base class for identifying a “User” in the database.

Class: Abstract UserId

| | | |
|---|---|---|
| Property Name | Type | Notes |

| | |
|---|---|
| Type | Int |

Passport Id Class

Class: PassportId:UserId

| | | |
|---|---|---|
| Property Name | Type | Notes |

| | |
|---|---|
| Puid | Int64 |

AltPassportId Class

In some embodiments, AltUserId class may be the base class for alternate IDs in the database. For example, alternate IDs may be encrypted or one way hashed versions of the User ID that can be safely exposed outside the system without risk of compromising customer data.

Class: Abstract AltUserId

| | | |
|---|---|---|
| Property Name | Type | Notes |

| | |
|---|---|
| Type | Int |

AltPassport Class

AltPassportId is an example of an allowed instance of the AltUserId abstract base class. Such a class, for example, may correspond to a format of data generated by passport server 450 (FIG. 4).

Class: AltPassportId: AltUserId

Property Name Type Notes

Cid Int64 One way hash of a Passport Puid

UserMasterPrivacy Class

Class: UserMasterPrivacy

| | | |
|---|---|---|
| Property Name | Type | Notes |

| | |
|---|---|
| NoThirdPary | Bool |
| NoCritical | Bool |
| Suppressed | Bool |

UserContactPrivacy Class

Class: UserMasterPrivacy

| | | |
|---|---|---|
| Property Name | Type | Notes |

| | |
|---|---|
| NoThirdPary | Bool |
| NoUnsolicited | Bool |
| Suppressed | Bool |

Address Class

Class: Address

| Property | | |
|---|---|---|
| Name | Type | Notes |
| Type | Int | AddressType (plus user ID) is a |
| | | unique identifier. A user can only |
| | | have one entry for each |
| | | AddressType. AddressType is |
| | | validated as an acceptable Int |
| | | value prior to writing data to |
| | | the database |
| Address1 | String | |
| Address2 | String | |
| Address3 | String | |
| Department | String | |
| City | String | |
| Region | String | |
| PostalCode | String | |
| Country | String | The expected value is a 2 character |
| | | ISO 3166 country code. |
| Privacy | UserContactPrivacy | |
| Changes | Enum: | |
| | AddressProperties | |

Email Class

Class: Email

| Property Name | Type | Notes |
|---|---|---|
| Address | String | Validation: Cannot by NULL or |
| | | empty string |
| Type | Int | EmailType (plus user ID) is a |
| | | unique identifier. A user can only |
| | | have one entry for each |
| | | EmailType. EmailType is |
| | | validated as an acceptable Int |
| | | value prior to writing data |
| | | to the database. |
| NonDeliverable | Boolean | |
| ValidationState | Boolean | For read-only use, value ignored |
| | | when writing to database |
| ValidatedDate | DateTime | |
| Privacy | UserContactPrivacy | |
| Changes | Enum: | |
| | EmailProperties | |

Phone Class

Class: Phone

| Property | | |
|---|---|---|
| Name | Type | Notes |
| Type | Int | PhoneType (plus user ID) may serve |
| | | as a unique identifier. In such an |
| | | embodiment, a user can only have |
| | | one entry for each type. PhoneType |
| | | is validated as an acceptable Int |
| | | value prior to writing data to the |
| | | database. |
| CountryCode | String | |
| AreaCode | String | |
| Number | String | Validation: Cannot by NULL or |
| | | empty string |
| Extension | String | |
| Privacy | UserContactPrivacy | |
| Changes | Enum: | |
| | PhoneProperties | |

Agressment Class

Class: Agreement

| Property | | |
|---|---|---|
| Name | Type | Notes |
| Id | int | Id (plus user ID) is a unique |
| | | identifier. A user can only |
| | | have one Agreement entry for |
| | | each Agreement Id within a |
| | | collection of agreements. A |
| | | user may have multiple |
| | | collections of agreements, |
| | | one at the User level and one |
| | | per Subscription. |
| SubscriptionId | String | The ID of the subscription with |
| | | which this agreement is |
| | | associated. Null if the |
| | | agreement is associated |
| | | directly with the User rather |
| | | than a subscription. For |
| | | read-only use, value |
| | | ignored when writing to |
| | | database. |
| Version | String | Stores the version number of |
| | | the agreement as an unformatted |
| | | string. Validation: Cannot |
| | | be NULL or empty string. |
| Changes | Enum: | |
| | AgreementProperties | |

QuestionAnswer Class

Class: QuestionAnswer

| Property | | |
|---|---|---|
| Name | Type | Notes |
| QuestionId | String | QuestionId (plus user ID) |
| | | is a unique identifier. A |
| | | user can only have one |
| | | QuestionAnswer entry |
| | | for each QuestionId |
| | | within a collection of |
| | | question answers. A |
| | | user may have multiple |
| | | collections of question |
| | | answers, one at the User |
| | | level and one per |
| | | Subscription. |
| SubscriptionId | String | The ID of the subscription |
| | | with which this question |
| | | answer is associated. |
| | | Null if the question answer |
| | | is associated directly with |
| | | the User rather than a |
| | | subscription. For read-only |
| | | use, value ignored when |
| | | writing to database. |
| Type | Int | Type is validated as an |
| | | acceptable Int value prior |
| | | to writing data to the DB. |
| | | Allowed value(s) for the |
| | | dev DB are: |
| | | 1 (IdValue) |
| | | 2 (IntegerValue) |
| | | 3 (TextValue) |
| AnswerValue | String | Validation: Cannot be |
| | | NULL or empty string. If |
| | | Type is 1 or 2 the value |
| | | is validated for parsing |
| | | as Int. When type is 1 |
| | | the value is not checked |
| | | for allowed AnswerId |
| | | values prior to DB write |
| | | operation. Operation will |
| | | fail at write time. |
| Changes | Enum: | |
| | QuestionAnswerProperties | |

CustomProperty Class

Class: CustomProperty

| Property | | |
|---|---|---|
| Name | Type | Notes |
| Id | Int | Id (plus user ID) is a unique identifier. |
| | | A user can only have one entry for each |
| | | customproperty Id within a collection |
| | | of customproperties. A user may have |
| | | multiple collections of |
| | | customproperties, one at the User |
| | | level and one per Subscription. |
| SubscriptionId | String | The ID of the subscription with which |
| | | this customproperty is associated. Null |
| | | if the customproperty is associated |
| | | directly with the User rather than a |
| | | subscription. For read-only use, value |
| | | ignored when writing to database. |
| AttributeValue | String | Validation: none |
| Changes | Enum: | |
| | CustomPropertyProperties | |

Product Class

Class: Product

| Property Name | Type | Notes |
|---|---|---|
| Alias | String | Alias is the unique identifier for |
| | | a product. A user can only have |
| | | one entry for a particular product |
| | | Alias. |
| IncludeInSearch | Bool | |
| IsInstalled | Bool | |
| Changes | Enum: | |
| | ProductProperties | |

ProductRegistration Class

Class: ProductRegistration

| Property Name | Type | Notes |
|---|---|---|
| OrderSource | String | OrderSource together with OrderId and |
| | | UserId are a unique identifier for a |
| | | productregistration entry. A user can |
| | | only have one entry for a particular |
| | | OrderSource and OrderId. |
| OrderId | Bool | |
| TransactionDate | DateTime | |
| RegistrationDate | DateTime | |
| PidAssigned | String | |
| PartLanguage | String | |
| Sku | String | |
| ReferrerId | String | |
| OemCode | String | |
| Redirect | String | |
| RedirectLabel | String | |
| RedirectCategory | String | |
| TrialSku | String | |
| TrailLanguage | String | |
| TrialSource | String | |
| TrialDownloadDate | DateTime | |
| ProgramCode | String | |
| TrialKeyAssigned | String | |
| CreatedDate | DateTime | |

OfferInfo Class

Class: OfferInfo

| Property | | |
|---|---|---|
| Name | Type | Notes |
| Id | Guid | Id is the unique identifier for an OfferInfo |
| | | object. The Id is not checked for allowed |
| | | values prior to DB write operation. |
| | | Operation will fail at write time. |
| SCGOffer | Bool | |
| Description | String | |

In the embodiment illustrated, there is no Changes field on OfferInfo. Offers cannot be changed by external callers and are only updated via internal operations. Other objects for which updates are not to be made by services placing calls through the interface may similarly lack a Changes field. Selectively omitting the Changes field from class definitions in this fashion is one mechanism by which certain methods may be restricted for certain objects.

Subscription Class

Class: Subscription

| Property Name | Type | Notes |
|---|---|---|
| Id | String | Id is the unique identifier. |
| SubscriptionId | SubscriptionId | |
| Offer | OfferInfo | |
| State | Int | |
| BillingLocale | String | |
| DisplayLocale | String | |
| TokenId | String | |
| Agreements | Agreement[ ] | |
| QuestionAnswers | QuestionAnswer[ ] | |
| CustomProperties | CustomProperty[ ] | |
| Created | DateTime | In addition to standard |
| | | Modified property also |
| | | includes Created time. |
| Changes | Enum: | |
| | SubscriptionProperties | |

SubscriptionId Class

Class: abstract SubscriptionId

| | | |
|---|---|---|
| Property Name | Type | Notes |

SCGubscriptionId Class

Class: abstract SCGSubscriptionId

| Property Name | Type | Notes |
|---|---|---|
| SCGId | String | SCGId is the unique identifier. |

Further classes may be defined to describe data objects associated with subscriptions. For example, the following psuedo-code provides an example of further classes that may define the interface.

```
public class Organization
{
  public SubscriptionId SubscriptionId;
  /// <remarks/>
  public int State;
  /// <remarks/>
  public bool IsSmallBusiness;
  /// <remarks/>
  public string OrganizationName;
  /// <remarks/>
  public Uri LogoUrl;
  public string Description;
  public string HoursOfOperation;
  public int Category;
  public string Locale;
  public TimeZoneRange TimeZone;
  public Address[ ] Addresses;
  public Phone[ ] Phones;
  public Email[ ] Emails;
  public QuestionAnswer[ ] QuestionAnswers;
  public CustomProperty[ ] CustomProperties;
  public Agreement[ ] Agreements;
  public OrganizationProperties Changes;
  public System.DateTime Modified;
  public System.DateTime Created;
  public string ClientErrorData;
}
  [Flags]
  public enum OrganizationProperties
  {
    SmallBusiness = 0x4,
    Name = 0x8,
    LogoUrl = 0x10,
    Description = 0x20,
    HoursOfOperation = 0x40,
    Category = 0x80,
    Addresses = 0x100,
    Phones = 0x200,
    Emails = 0x400,
    Locale = 0x800,
    TimeZone = 0x1000,
    QuestionAnswers = 0x2000,
    CustomProperties = 0x4000,
    Agreements = 0x8000,
  }
// Offer meta data
public class OfferConfiguration
{
  public Offer[ ] Offers;
  public enum UnitType
  {
    Disk,
    User,
    Bandwidth,
    Mailbox
  }
  public enum ComponentGroup : uint
  {
    Shell = 0, // Shell components.
    Core = 1, // Core components provisioned during sign-up.
    Mailbox = 2, // Subscription owner e-mail components.
    Dependent = 4, // Components provisioned by other components (FC
    pro).
  }
  public class Addon
  {
    public Guid AddonOfferId;
    public int MaxCount;
  }
  public class OfferType
  {
    public int OfferTypeId;
    public string Description;
  }
  public class SKU
  {
    public int SKUId;
    public string Description;
  }
  public class ComponentUnitCount
  {
    public UnitType Type;
    public int UnitCount;
  }
  public class ClusterComponent
  {
    public int Weight;
    public string Url;
    public bool Active;
  }
  public class OfferConversion
  {
    public Guid FromOffer;
    public Guid ToOffer;
    public bool Upgrade;
  }
  public class ComponentConversion
  {
    public Guid FromComponent;
    public Guid ToComponent;
  }
  public class Component
  {
    public Guid ComponentGuid;
    public Guid ParentComponentId;
    public string Name;
    public bool Shell;
    public bool Tenant;
    public int AbilitySetId;
    public int CapabilitySetId;
    [XmlElement(Type = typeof(ComponentConversion))]
    public ArrayList ToConversions;
    [XmlElement(Type = typeof(ComponentConversion))]
    public ArrayList FromConversions;
    [XmlElement(Type = typeof(ClusterComponent))]
    public ArrayList Clusters;
    [XmlElement(Type = typeof(ComponentUnitCount))]
    public ArrayList ComponentUnitCounts;
    [XmlElement(Type = typeof(ComponentGroup))]
    public ArrayList ComponentGroups;
  }
  public class Offer
  {
    public Guid OfferId;
    public bool SCGOffer;
    public bool Trial;
    public bool TokenBased;
    public bool CreditCardBased;
    public bool Addon;
    public int InternalOfferId;
    public string Name;
    public string DomainTLD;
    public string Locales;
    public DateTime StartDate;
    public DateTime EndDate;
    public string PriceDescription;
    public string Currency;
    public SKU SKUId;
    public string TOUVersion;
    public Guid SignupExperienceId;
    public int TrialPeriod;
    public int GracePeriod;
    public SKU SKUInfo;
    public OfferType OfferTypeInfo;
    [XmlElement(Type = typeof(Addon))]
    public ArrayList Addons;
    [XmlElement(Type = typeof(OfferConversion))]
    public ArrayList FromConversions;
    [XmlElement(Type = typeof(OfferConversion))]
    public ArrayList ToConversions;
    [XmlElement(Type = typeof(Component))]
    public ArrayList Components;
  }
}
```

In addition, the interface may be defined by one or more “views,” that allow only a portion of the data

### User Data Views

For performance and efficiency reasons execution of a method may result in return to the calling service acting as a client of the data service only that data that is required by the calling service. Accordingly, one or more “views” of client data may be provided and a method may include specification of a “view” to be returned. A returned object will only have the properties which correspond to the specified View populated, other properties will have null or default values.

The examples below illustrate “views” of User objects. Though not expressly illustrated in the examples, views may alternatively or additionally be defined for other classes of objects.

Core View

| | | |
|---|---|---|
| User Property | Class | Notes |

| | |
|---|---|
| User | User |
| User.Name | UserName |

Contact View

| | | |
|---|---|---|
| User Property | Class | Notes |

| | |
|---|---|
| User | User |
| User.Name | UserName |
| User.Addresses | Address |
| User.Phones | Phone |
| User.Emails | Email |

Contact And Subscription View

| | | |
|---|---|---|
| Parent.Child Property | | |
| Relationship | Class | Notes |

| | |
|---|---|
| User | User |
| User.Name | UserName |
| User.Addresses | Address |
| User.Phones | Phone |
| User.Emails | Email |
| User.Agreements | Agreement |
| User.CustomProperties | CustomProperty |
| User.QuestionAnswers | QuestionAnswers |
| User.Subscriptions | Subscription |
| Subscription.Agreements | Agreement |
| Subscription.CustomProperties | CustomProperty |
| Subscription.QuestionAnswers | QuestionAnswers |

Complete View

Equivalent to Contact And Subscription view plus the following:

| User Property | Class | Notes |
|---|---|---|
| User.Products | Product | |
| User.ProductRegistrations | ProductRegistration | |

SOAP Methods

In addition, an interface to a data service may be defined by one or more methods that may be called through the interface. A subset of the methods that may be included in an interface are listed below as an example of methods that may be provided.

The subset below includes methods that manipulate objects of type User. Though not expressly listed in the examples below, other methods may be provided to manipulate other classes of objects. For example, a class may be defined for organizations, which may have a separate set of methods. Likewise, other methods may be defined to perform functions appropriate for managing the storage of data associated with subscriptions or other objects that may be processed by a data service.

Method: AddUser( )

| Parameters | Type | Notes |
|---|---|---|
| users | User[ ] | Only properties corresponding to set flags in |
| | | the Changes property of the User object (and |
| | | child objects) will be set in the database. |

Returns: void

Method: UpdateUser( )

| Parameters | Type | Notes |
|---|---|---|
| users | User[ ] | Only properties corresponding to set flags in |
| | | the Changes property of the User object |
| | | (and child objects) will be set in the database |

Returns: void

Method: DeleteUser

| Parameters | Type | Notes |
|---|---|---|
| Ids | UserId[ ] | Access to this API is restricted |

Returns: void

Method: FindUser

| Parameters | Type | Notes |
|---|---|---|
| Ids | UserId[ ] | |
| view | Enum: | Enum which controls how much of the user |
| | UserView | object is populated with data |

Returns: User[]

Further examples of methods that may be part of the interface include the following:

GetOfferConfiguration

This method returns Offer meta data for the given Offers

Public OfferConfiguration GetOfferConfiguration (Guid[] offersOfinterest)
This method takes offer ids as input and returns the meta data associated with those offers
This method is only available to trusted partners (not available to LTG or eventually calls coming directly from client)
If no offer Guid is passed OR an invalid offer id is passed in input, the method will throw an exception

AddSubscription
[SoapHeader (“ApplicationIdHeader”)]

Public void AddSubscription(Subscription subscription)

Semantics of AddUser apply
Changes must be set to 0.
SubscriptionId cannot be null
Subscription cannot be null
Before a UserComponent can be added to a subscription, if a user does not exist in UserDB, User will be created in UserDB.
When a UserComponent is added, a link is automatically added in UserDB to keep track of all subscriptions associated with a User. The link is added asynchronously. Pubsub mechanism is used for this.

UpdateSubscription
[SoapHeader (“ApplicationIdHeader”)]

Public void UpdateSubscription(Subscription subscription)

Semantics of UpdateUser apply
subscription.Changes must not be set to 0.
subscription.Id cannot be null
When a UserComponent is added, a link is automatically added in UserDB to keep track of all subscriptions associated with a User. The link is added asynchronously. Pubsub mechanism is used for this.

DeleteSubscription
[SoapHeader (“AppiicationIdHeader”)]

Public void DeleteSubscription(string subscriptionId)

Semantics of DeleteUser apply
This is an internal method, not available to partners. It is only available on test clusters. It is not available on IntPerf, live site and PPE environments.
SubscriptionId cannot be null
When a UserComponent is deleted that results in a user being removed from a subscription completely, the existing link is automatically removed from UserDB. The link is removed asynchronously. Pubsub mechanism is used for this.

FindSubscription
[SoapHeader (“ApplicationIDHeader”)]

Public Subscription FindSubscription(string subscriptionId, SubscriptionView view)

Semantics of FindUser apply
Subscription.Id cannot be null
SubscriptionView needs to be a valid view

AddOrganization
[SoapHeader (“ApplicationIdHeader”)]
Public void AddOrganization(Organization organization) Semantics of AddUser apply
Changes must be set to 0.
SubscriptionId cannot be null
Subscription cannot be null

UpdateOrganization
[SoapHeader (“ApplicationIdHeader”)]

Public void UpdateOrganization(Organization organization)

Semantics of UpdateUser apply
subscription.Changes must not be set to 0.
subscription.Id cannot be null

DeleteOrganization
[SoapHeader (“ApplicationIdHeader”)]

Public void DeleteOrganization(SubscriptionId subscriptionId)

Semantics of DeleteUser apply
SubscriptionId cannot be null

FindOrganization
[SoapHeader (“ApplicationIdHeader”)]

Public Subscription FindOrganization(SubscriptionId subscriptionId, OrganizationView view)

Semantics of FindUser apply
SubscriptionId cannot be null
view needs to be a valid view

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method comprising:
providing, by a data service implemented by a web server, an Application Programming Interface (API) to different client services which are each implemented by one or more server devices, the API providing a framework for the different client services to store user data and subscription data in a database maintained by the data service, wherein each different client service establishes subscriptions that entitle individual users to access a specific type of service over a network and places calls to the data service through the API to store information related to the individual users and the subscriptions, the API comprising:
a user class to add or update user data in the database maintained by the data service, the user class defining properties of a data object in which the user data may be stored, wherein the user class includes a field that can set by each different client service to indicate which properties are set in the database for user data related to each different client service;
methods to add a user, update a user, and find a user that can be called by the different client services;
a subscription class to add or update subscription data in the database maintained by the data service, the subscription class defining properties of a data object in which the subscription data may be stored, wherein the subscription class includes a field that can be set by each different client service to indicate which properties are set in the database for subscription data related to each different client service; and
methods to add a subscription, update a subscription, and find a subscription that can be called by the different client services.

2. The method of claim 1, wherein:
the user class defines a property having a type corresponding to the subscription class.

3. The method of claim 1, wherein:
the API comprises a user identifier class for identifying users in the database, and
the user class defines a property having a type corresponding to the user identifier class.

4. The method of claim 3, further comprising:
creating an instance of the user identifier class for identifying a particular user in the database based on a passport identifier generated for the particular user by a passport server.

5. The method of claim 1, wherein:
the API comprises an agreement class for identifying agreements associated with users or subscriptions, and
at least one of the user class or the subscription class defines a property having a type corresponding to the agreement class.

6. The method of claim 1, wherein:
the API comprises a custom property class for allowing the different client services to define service specific information, and
at least one of the user class or the subscription class defines a property having a type corresponding to the custom property class.

7. The method of claim 1, wherein:
the API comprises a product class for identifying products associated with users, and
the user class defines a property having a type corresponding to the product class.

8. The method of claim 1, wherein:
one or more of the different client services establishes subscriptions that entitle users within an organization to access one or more services based on a subscription agreement with the organization,
the API comprises a class defined for organizations and methods to add an organization, update an organization, and find an organization that can be called by the different client services.

9. The method of claim 1, wherein:
the data service provides multiple views of the user data and the subscription data stored in the database, and
the methods to find a user or find a subscription are configured to receive call parameters which include a specified view and to return a data object populated only with values for properties which correspond to the specified view.

10. A computing system comprising:
a processor configured to execute computer-executable instructions; and
memory storing computer-executable instructions for:
providing, by a data service implemented by the computing system, an Application Programming Interface (API) to different client services which are each implemented by one or more server devices, the API providing a framework for the different client services to store user data and subscription data in a database maintained by the data service, wherein each different client service establishes subscriptions that entitle individual users to access a specific type of service over a network and places calls to the data service through the API to store information related to the individual users and the subscriptions, the API comprising:
a user class to add or update user data in the database maintained by the data service, the user class defining properties of a data object in which the user data may be stored, wherein the user class includes a field that can set by each different client service to indicate which properties are set in the database for user data related to each different client service;
methods to add a user, update a user, and find a user that can be called by the different client services;
a subscription class to add or update subscription data in the database maintained by the data service, the subscription class defining properties of a data object in which the subscription data may be stored, wherein the subscription class includes a field that can be set by each different client service to indicate which properties are set in the database for subscription data related to each different client service; and
methods to add a subscription, update a subscription, and find a subscription that can be called by the different client services.

11. The computing system of claim 10, wherein:
the user class defines a property having a type corresponding to the subscription class.

12. The computing system of claim 10, wherein:
the API comprises a user identifier class for identifying users in the database, and
the user class defines a property having a type corresponding to the user identifier class.

13. The computing system of claim 12, wherein the memory further stores computer-executable instructions for:
creating an instance of the user identifier class for identifying a particular user in the database based on a passport identifier generated for the particular user by a passport server.

14. The computing system of claim 10, wherein:
the API comprises an agreement class for identifying agreements associated with users or subscriptions, and
at least one of the user class or the subscription class defines a property having a type corresponding to the agreement class.

15. The computing system of claim 10, wherein:
the API comprises a custom property class for allowing the different client services to define service specific information, and
at least one of the user class or the subscription class defines a property having a type corresponding to the custom property class.

16. The computing system of claim 10, wherein:
the API comprises a product class for identifying products associated with users, and
the user class defines a property having a type corresponding to the product class.

17. The computing system of claim 10, wherein:
one or more of the different client services establishes subscriptions that entitle users within an organization to access one or more services based on a subscription agreement with the organization,
the API comprises a class defined for organizations and methods to add an organization, update an organization, and find an organization that can be called by the different client services.

18. The computing system of claim 10, wherein:
the data service provides multiple views of the user data and the subscription data stored in the database, and
the methods to find a user or find a subscription are configured to receive call parameters which include a specified view and to return a data object populated only with values for properties which correspond to the specified view.

19. A computer-readable storage device storing computer-executable instructions that, when executed, cause a computing device to:
provide, by a data service implemented by the computing device, an Application Programming Interface (API) to different client services which are each implemented by one or more server devices, the API providing a framework for the different client services to store user data and subscription data in a database maintained by the data service, wherein each different client service establishes subscriptions that entitle individual users to access a specific type of service over a network and places calls to the data service through the API to store information related to the individual users and the subscriptions, the API comprising:
a user class to add or update user data in the database maintained by the data service, the user class defining properties of a data object in which the user data may be stored, wherein the user class includes a field that can set by each different client service to indicate which properties are set in the database for user data related to each different client service;
methods to add a user, update a user, and find a user that can be called by the different client services;
a subscription class to add or update subscription data in the database maintained by the data service, the subscription class defining properties of a data object in which the subscription data may be stored, wherein the subscription class includes a field that can be set by each different client service to indicate which properties are set in the database for subscription data related to each different client service; and
methods to add a subscription, update a subscription, and find a subscription that can be called by the different client services.

20. The computer-readable storage device of claim 19, wherein:
the API comprises a custom property class for allowing the different client services to define service specific information, and
at least one of the user class or the subscription class defines a property having a type corresponding to the custom property class.
